(19) United States
(12) Patent Application Publication
(10) Pub. No.: US 2006/0201276 A1
(43) Pub. Date: Sep. 14, 2006

(54) Position control mechanism

(75) Inventors: Ken Nomura, Kamakura-shi (JP); Seiji Uno, Minato-ku (JP); Daisuke Kato, Mino-shi (JP)

Correspondence Address: WOLF BLOCK SCHORR AND SOLIS-COHEN LLP, 250 PARK AVENUE, NEW YORK, NY, 10177, US

(73) Assignee: Nippon Thompson Co., Ltd., Minato-ku (JP)

(21) Appl. No.: 11/360,297

(22) Filed: Feb. 23, 2006

(30) Foreign Application Priority Data
Feb. 24, 2005 (JP) 2005-048533

(51) Int. Cl. H02K 41/02

(52) U.S. Cl. 74/490.13

(57) ABSTRACT

A position control mechanism as here provided is capable of controlling the position of a control object in any of the fore-aft directions and the rotation directions without producing heat and dust. Air slides (S1, S2) are respectively mounted integrally with a pair of linear motors (M1, M2). First coupling members (6, 7) are respectively attached to the air slides and move integrally with them. Second coupling members (10, 11) are placed opposite each other and respectively attached to the first coupling members and allowed to rotate with respect to the first coupling members. Linear bearings (12, 13) are provided between the opposing sides of the second coupling members (10, 11). A pair of the second coupling members are relatively movable through the linear bearings. A moving body (14) is fixed to one of the pair of second coupling members.

### FIELD OF THE INVENTION

This invention relates to a position control mechanism suitable for use in semiconductor manufacturing apparatus, machine tools, industrial robots and the like.

### DESCRIPTION OF THE RELATED ART

A turntable is often used for controlling the angle of a control object in the horizontal direction, for example. The conventional turntable is supported at its rotating shaft by a bearing. Therefore, the rotational center of the turntable is fixed so as to prevent intentional displacement of the rotational center.

Note that the turntable is usually used for controlling the angle of a control object in the horizontal direction, so that no patent search has been particularly conducted with regard to it.

Because a conventional turntable as described above is fixed at its rotational center, it is impossible to control the rotational angle about a displaced center or to control the position in the fore-aft direction. This gives rise to the problem of the limitation of unrestricted position control.

Further, when heat is generated from a power transmission mechanism such as a motor serving as a drive source, a ball screw, a gear and the like, each member of the turntable is expanded by the heat, which in turn sometimes affects precise position control. In addition, if the motor or the like produces heat, the heat causes seizing-up of the motor. For prevention of the seizing-up, a reduction in takt time is required. It goes without saying that a reduction in takt time means an increase in the time required for positioning, thus affecting swift position-control operation.

Further, the bearing of the turntable includes grease or oil. Therefore, when a semiconductor manufacturing apparatus required to be used in a clean environment includes the position control mechanism, easy occurrence of dust caused by the grease, the oil, wear powder or the like results. In particular, the semiconductor manufacture requires high takt-time operation. This increasingly increases the amount of dust produced from the bearing portion of the semiconductor manufacturing apparatus, which then gives rise to the disadvantage of disrupting the manufacture of the semiconductors.

### SUMMARY OF THE INVENTION

It is an object of the present invention to provide a position control mechanism which is capable of controlling position of a control subject in any direction among the fore-and-aft directions and the rotation directions.

Another object of the present invention is to provide a position control mechanism which produces no dust and generates no heat as well as being capable of controlling position of a control subject in any direction among the fore-and-aft directions and the rotation directions.

In a first aspect of the present invention, a position control mechanism comprises: first coupling members respectively mounted to a pair of linear drivers and moving integrally with the linear drivers; second coupling members placed opposite each other and respectively attached to the first coupling members and allowed to rotate with respect to the first coupling members; and linear bearings provided between opposing portions of the second coupling members, wherein a pair of the second coupling members are relatively movable through the linear bearings, and a moving body is fixed to one of the pair of second coupling members.

In a second aspect of the present invention, a position control mechanism comprises: first coupling members respectively mounted to a pair of linear drivers and moving integrally with the linear drivers; second coupling members placed opposite each other and respectively attached to the first coupling members and allowed to rotate with respect to the first coupling members; a moving body placed between opposing portions of the second coupling members; and linear bearings provided between opposing portions of the moving body and the second coupling members, wherein a pair of the second coupling members and the moving body are relatively movable through the linear bearings.

In a third aspect of the present invention, a position control mechanism comprises: air slides respectively mounted integrally with a pair of linear motors; first coupling members respectively attached to the air slides and moving integrally with the air slides; second coupling members placed opposite each other and respectively attached to the first coupling members and allowed to rotate with respect to the first coupling members; and linear bearings provided between opposing portions of the second coupling members, wherein a pair of the second coupling members are relatively movable through the linear bearings, and a moving body is fixed to one of the pair of second coupling members.

According to the first and second aspects of the present invention, the individual control of the moving positions of a pair of linear drivers makes it possible to vary the rotation center of the moving body up to a certain point, thereby widening the range of angular adjustment and the scope of the applications thereof.

According to the third aspect, the following advantageous effects are provided in addition to the fact that the rotation center of a moving body can be varied up to a certain point.

Because, firstly, the linear motors are provided integrally with the air slides and the first and second coupling members are supported with the air slides, even if the load of the first and second coupling members and the moving body mounted on the first and second coupling members acts on the air slides, heat or dust is not produced from the acting point. Thus, the position control mechanism according to the present invention is the control mechanism which is also best suited for semiconductor manufacturing apparatus which requires use in a clean environment.

### BRIEF DESCRIPTION OF THE DRAWINGS

FIG. 1 is a plan view of a first embodiment.

FIG. 2 is a plan view illustrating one direction of controlling a mobile unit.

FIG. 3 is a plan view illustrating one direction of controlling a mobile unit.

FIG. 4 is a plan view illustrating one direction of controlling a mobile unit.

FIG. 5 is a plan view illustrating one direction of controlling a mobile unit.

FIG. 6 is a diagram illustrating a second embodiment.

FIG. 7 is a diagram illustrating a third embodiment.

### DETAILED DESCRIPTION OF THE PREFERRED EMBODIMENTS

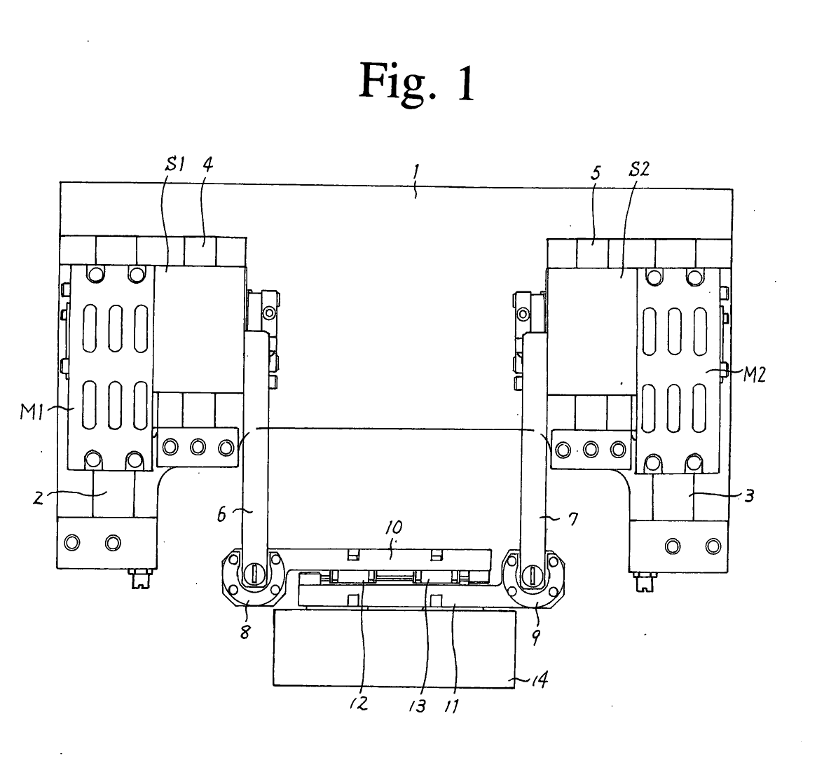

In a first embodiment illustrated in FIG. 1 to FIG. 5, a pair of round-shaft-type air slides S1, S2 is provided integrally with a pair of round-shaft-type linear motors M1, M2, respectively. The linear motors M1, M2 are respectively mounted slidably along round-shaft-type rails 2, 3 which extend across a body 1. The air slides S1, S2 respectively move along round-shaft-type rails 4, 5 extending parallel to the rails 2, 3, and are combined with the respective linear motors M1, M2. As the linear motors M1, M2 move along the rails 2, 3, the air slides S1, S2 also move along the rails 4, 5.

A linear encoder (not shown) is placed on one side of each of the air slides S1, S2 for positional detection.

The air sliders S1, S2, which are of a well-known type, move by the action of air pressure which keeps them out of contact with the rails 4, 5.

The pair of air slides S1, S2 structured in this manner is respectively fixed to one of the ends of first coupling members 6, 7. The other ends of the first coupling members 6, 7 are respectively coupled to second coupling members 10, 11 through angular bearings 8, 9, such that the second coupling members 10, 11 are rotatable with respect to the first coupling members 6, 7. Further, the pair of second coupling members 10, 11 are placed parallel and opposite to each other while being at right angles to the respective first coupling members 6, 7. Linear bearings 12, 13 are provided between the opposing portions of the pair of second coupling members 10, 11 to interface between the coupling members 10, 11. The linear bearings 12, 13, which are of a well-known type, couple the second coupling members to each other while keeping them in a relatively movable state.

Further, a moving body 14 is fixed to one second coupling member 11 of the second coupling members 10, 11. The moving body 14 itself may be a position control object, or a substance placed on the moving body 14 may be a position control object.

Next, the operation in the first embodiment will be described.

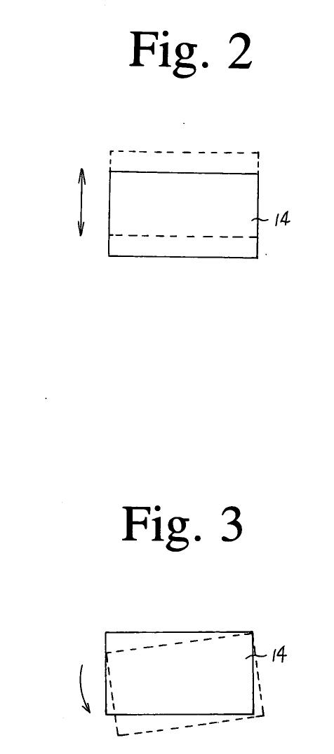

The linear motors M1, M2 are simultaneously driven, whereupon the air slides S1, S2 also move along the rails 4, 5. At this point, when the amounts of relative movement of the linear motors M1, M2 are equal, the moving body 14 is controlled in position in the fore-aft direction as shown in FIG. 2.

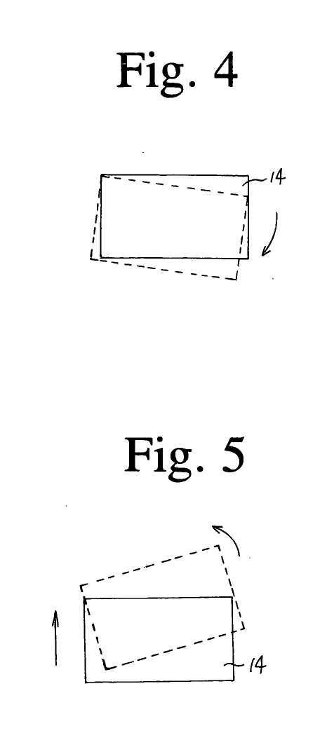

When the amounts of relative movement of the linear motors M1, M2 differ from each other, the moving body 14 can be rotated at an angle θ in the clockwise direction or in the counterclockwise direction as shown in FIG. 3 and FIG. 4. In this connection, when the moving body 14 thus rotates at an angle θ, the distance between the centers of the angular bearings 8, 9 is longer than that when the moving body 14 is positioned at right angles to the first coupling members 6, 7. When the distance between the centers of the angular bearings 8, 9 is increased in this manner, the second coupling members 10, 11 move relatively through the linear bearings 12, 13 to absorb the change in length.

Further, when the moving body 14 is rotated in a position where the moving body 14 has traveled in the fore-aft direction, the position control is performed on the moving body 14 in a combination of the fore-aft direction and the rotation direction as shown in FIG. 5.

In either case, according to the first embodiment, the position control is able to be performed on the moving body 14 in either the rotation direction or the fore-aft direction, and also in a combination of the rotation direction and the fore-aft direction. As compared with the case of a conventional turntable, the degree of freedom in the control directions is significantly increased. An increase in the degree of freedom in the control directions enables a variety of position controls for different purposes and also dramatically widens the scope of application of the position control mechanism.

Further, according to the first embodiment, the use of the air slides S1, S2 effects a reduction in the mechanical contact area. Such a reduction in the mechanical contact area effects a reduction in the amount of heat produced and the amount of dust produced. In consequence, the present invention is best suited as a positioning control mechanism for a semiconductor manufacturing apparatus which requires use in a clean condition. When the housing of each of the linear motors M1, M2 is made of aluminum having high thermal conductivity and long holes are engraved in the surface of the housing to increase the surface area, the dissipating property is enhanced. In consequence, it is possible to inhibit the thermal expansion of the linear motors M1, M2 from causing a reduction in the positioning accuracy.

The first embodiment uses the linear motors M1, M2, but the use of the linear motors M1, M2 is not necessarily required. For example, a nut member may be fitted in a screw shaft and the air slides S1, S2 may be fixed to the nut members. In this case, the combination of the screw shaft and the nut members constitutes the linear driver of the present invention. It is needless to say that the linear motor is included in the linear driver.

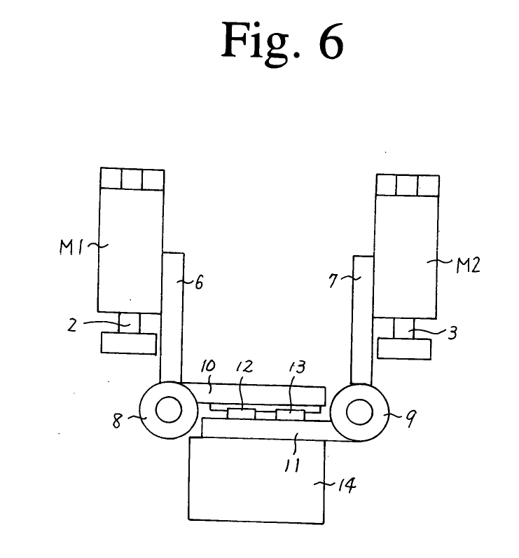

Further, in accordance with the intended use, the first coupling member may be directly fixed to the linear driver without the use of the air slides S1, S2. In a second embodiment illustrated in FIG. 6, the first coupling member is directly fixed to the linear driver in this manner.

The second embodiment is the same as the first embodiment, except that the ones of the ends of the first coupling members 6, 7 are fixed to the respective linear motors M1, M2 which are the linear drivers. Accordingly, in the second embodiment, the first coupling members 6, 7 and the second coupling members 10, 11 are rotatably coupled to each other through the angular bearings 8, 9. The pair of second coupling members 10, 11 are linked to each other in a manner allowing for relative movement through the linear bearings 12, 13. The moving body 14 is fixed to the second coupling member 11.

A position control mechanism according to the second embodiment structured as described above is best suited to applications requiring only precise position control and not requiring clean use conditions as in a semiconductor manufacturing apparatus.

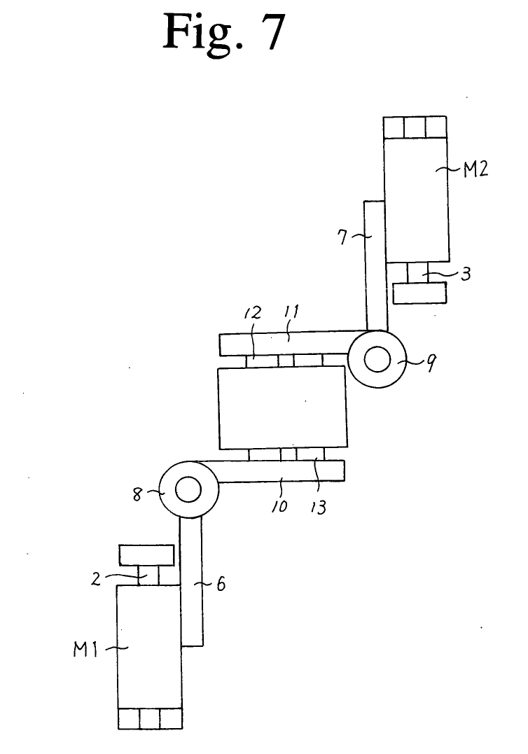

In a third embodiment illustrated in FIG. 7, a pair of linear motors M1, M2 which are the linear driver move integrally with the respective first coupling members 6, 7 and the ones of the ends of the first coupling members 6, 7 are fixed to the respective linear motors M1, M2. The first coupling members 6, 7 are respectively provided with the second coupling members 10, 11 which are placed opposite each other and rotatably with respect to the first coupling members 6, 7. The moving body 14 is placed between the opposing portions of the second coupling members 10, 11. Further, the linear bearings 12, 13 are provided in between the opposing sides of the moving body 14 and the second coupling members 10, 11. Accordingly, as in the case of the first and second embodiments, the pair of second coupling members 10, 11 and the moving body 14 are relatively movable through the linear bearings 12, 13.

It is needless to say that in the third embodiment the air slides S1, S2 may be provided so that the first coupling members 6, 7 are fixed to the air slides S1, S2.

A general concept of the position control mechanism according to the present invention includes, as well as the function of controlling the fore-aft position and the rotating position of the moving body 14, a transport mechanism for moving a moving body to a predetermined location which is provided by amply increasing the length of the rails 2, 3 and the rails 4, 5, for example.

What is claimed is:

1. A position control mechanism, comprising:
first coupling members respectively mounted to a pair of linear drivers and moving integrally with the linear drivers;
second coupling members placed opposite each other and respectively attached to the first coupling members and allowed to rotate with respect to the first coupling members; and
linear bearings provided between opposing portions of the second coupling members,
wherein a pair of the second coupling members are relatively movable through the linear bearings, and a moving body is fixed to one of the pair of second coupling members.

2. A position control mechanism, comprising:
first coupling members respectively mounted to a pair of linear drivers and moving integrally with the linear drivers;
second coupling members placed opposite each other and respectively attached to the first coupling members and allowed to rotate with respect to the first coupling members;
a moving body placed between opposing portions of the second coupling members; and
linear bearings provided between opposing portions of the moving body and the second coupling members,
wherein a pair of the second coupling members and the moving body are relatively movable through the linear bearings.

3. A position control mechanism, comprising:
air slides respectively mounted integrally with a pair of linear motors;
first coupling members respectively attached to the air slides and moving integrally with the air slides;
second coupling members placed opposite each other and respectively attached to the first coupling members and allowed to rotate with respect to the first coupling members; and
linear bearings provided between opposing portions of the second coupling members,
wherein a pair of the second coupling members are relatively movable through the linear bearings, and a moving body is fixed to one of the pair of second coupling members.
